(19) United States
(12) Patent Application Publication
(10) Pub. No.: US 2011/0316359 A1
(43) Pub. Date: Dec. 29, 2011

(54) BISTABLE LINEAR MOTOR

(76) Inventors: Steven F. McDaniel, Provo, UT (US); Robert F. Bennion, Las Vegas, NV (US)

(21) Appl. No.: 13/225,417

(22) Filed: Sep. 3, 2011

Related U.S. Application Data
(63) Continuation of application No. 11/747,212, filed on May 10, 2007.
(60) Provisional application No. 60/747,147, filed on May 12, 2006.

(51) Int. Cl. H02K 35/06

(52) U.S. Cl. 310/15

(57) ABSTRACT

A linear motor or generator includes a cylinder having left, center, and right magnetic portions interposed with left and right magnetic gaps, a left and a right induction coil axially wound around a longitudinal axis of the cylinder, and a flux bridge that magnetically couples the center magnetic portion to the left and right magnetic portions. The motor or generator also includes a flux modulating piston comprising a soft magnetic material for increasing magnetic flux circulation in the left flux path when the piston overlaps with the left magnetic gap and for increasing magnetic flux circulation in the right flux path when the piston overlaps with the right magnetic gap. The left and right magnetic portions of the cylinder may be made of a soft magnetic material that promotes magnetic flux.

### RELATED APPLICATIONS

This application is a continuation of U.S. patent application Ser. No. 11/747,212 entitled “PAIR-PISTON LINEAR ENGINE” and filed on 10 May 2007 for Robert F. Bennion which application claims the benefit of U.S. Provisional Application No. 60/747,147 entitled “PAIR-PISTON LINEAR ENGINE” and filed on 12 May 2006 for Robert F. Bennion and Steven F. McDaniel. Each of these applications are incorporated herein by reference.

### BACKGROUND OF THE INVENTION

1. Field of the Invention

This invention relates generally to motors and pumps and more particularly to linear motors and pumps.

2. Description of the Related Art

Currently available free-piston motors and generators are typically quite complex in construction and operation. What is needed is a free-piston motor or generator that is simple to build and operate.

### SUMMARY OF THE INVENTION

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The following description discloses various embodiments that are consistent with the claimed invention including:

A linear motor or generator comprising a cylinder having left, center, and right magnetic portions interposed with a left magnetic gap and a right magnetic gap, the left and right magnetic portions comprising a soft magnetic material, a left induction coil and a right induction coil axially wound around a longitudinal axis of the cylinder, a flux source for providing flux to the center magnetic portion, a flux bridge that provides a left flux path over the outer perimeter of the left induction coil and magnetically couples the center magnetic portion to the left magnetic portion, wherein the flux bridge further provides a right flux path over the outer perimeter of the right induction coil and magnetically couples the center magnetic portion to the right magnetic portion, and a piston comprising a soft magnetic material for increasing magnetic flux circulation in the left flux path when the piston overlaps with the left magnetic gap and for increasing magnetic flux circulation in the right flux path when the piston overlaps with the right magnetic gap.

The flux source may be hard magnet that magnetically connects the center magnetic portion to the flux bridge or one of the coils (having current flowing therein). Driving the piston (from an external source or via internal combustion) may modulate the flux that circulates around the left and right induction coils and generate electrical power therein. The flux bridge may be integral to a chassis of the linear motor or generator. The left magnetic gap and the right magnetic gap may be made of a non-magnetic material or air.

The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side cross-section view of a linear engine, in accordance with the present invention;

FIG. 2 is a side cross-section view of a linear engine having fuel injection, in accordance with the present invention;

FIG. 3A-3H are schematic cross-sectional views illustrating the progression of the linear engine through a five-phase combustion process, in accordance with the present invention;

FIGS. 4A-4D are side schematic views illustrating the progression of the linear engine through a cooling process, in accordance with the present invention;

FIGS. 5A-5E are side schematic views illustrating the progression of the linear engine through a pumping process, in accordance with the present invention;

FIG. 6 is a side cross-section view of a linear engine coupled with two linear switched reluctance motors, in accordance with one particular embodiment of the present invention;

FIG. 7 is a side cross-section view of a linear switched reluctance motor, in accordance with one particular embodiment of the present invention;

FIG. 8A-8C are side cross-section views of the motor of FIG. 6 illustrating the operations thereof, in accordance with one particular embodiment of the present invention;

FIG. 9 is a side cross-section view of an alternative embodiment of a linear switched reluctance motor, in accordance with one particular embodiment of the present invention;

FIG. 10 is a side cross-section view of yet another embodiment of a linear switched reluctance motor, in accordance with one particular embodiment of the present invention; and

FIG. 11 is a side cross-section view of a linear switched-reluctance motor having integrated pistons, in accordance with one particular embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

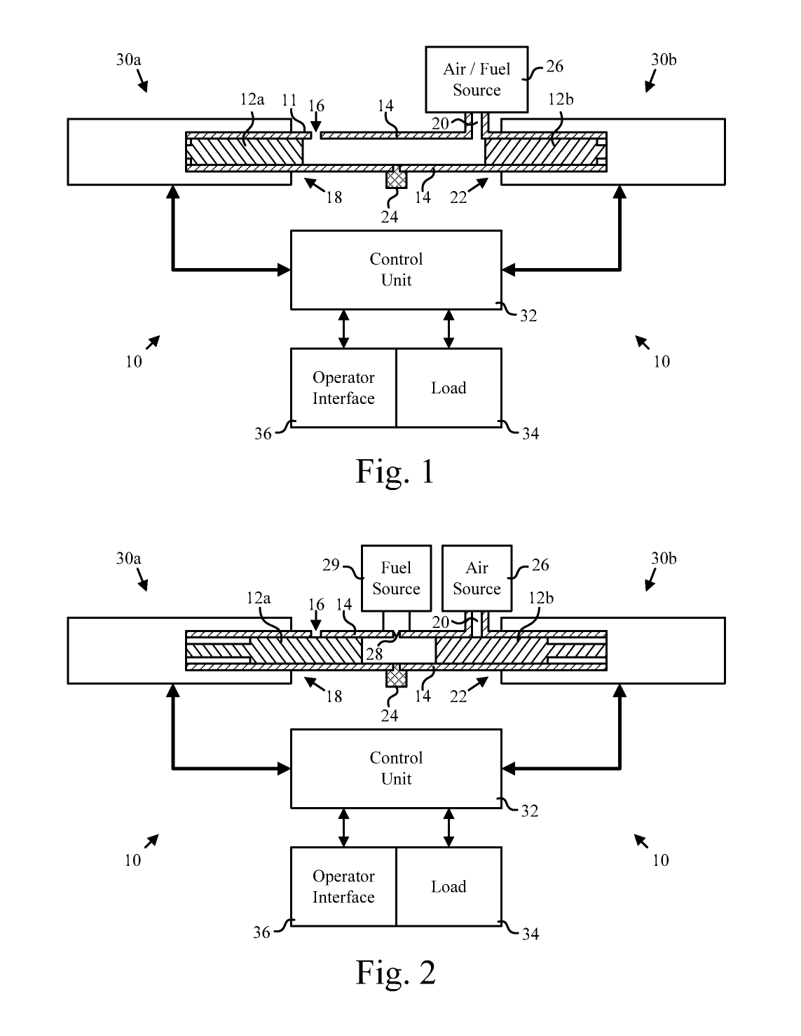

Referring to FIGS. 1 and 2, an engine 10 may include two pistons 12a, 12b positioned within a cylinder 14. The pistons 12a, 12b may be sized to slide within the cylinder 14 while providing a substantial seal against the flow of gases between the cylinder 14 and the pistons 12a, 12b. The cylinder 14 may have an exhaust port 16 formed near a proximal end 18 and an intake port 20 near a distal end 22. An igniting device 24 may introduce a spark, or other source of heat, into the cylinder to ignite a fuel/air mixture within the cylinder 14. The igniting device 24 may be embodied as a spark plug, glow plug, or like device.

The intake port 20 may be in fluid communication with a source of an intake fluid, such as an air source 26 or air/fuel source 26. The air-fuel source 26 may be a fuel injection system controlled to inject gas into an air stream as air flows into the cylinder 14. Alternatively, the air/fuel source 26 may be a carburetor. In some embodiments, air and fuel are mixed by the air-fuel source 26 into a homogeneous charge that is ignited by compression ignition within cylinder 14. Referring to FIG. 2, in some embodiments an air source 26 may be used in combination with a fuel injector 28 and separate fuel source 29 for injecting fuel directly into the cylinder 14 such as required by a diesel cycle.

The intake port 20 and exhaust port 16 may be sealed by the pistons 12a, 12b. Thus, to seal the exhaust port 16 and intake port 20 during the combustion stroke, the pistons 12a, 12b, respectively, need only be positioned thereover. Accordingly, no complex valving or timing mechanisms are required with their attendant friction loads.

The pistons 12a, 12b may drive, and be driven by, actuator/generators 30a, 30b, respectively. The actuator/generators 30a, 30b may be powered to move the pistons 12a, 12b through movements necessary to accomplish a fluid handling process, such as the Otto cycle, Diesel cycle, or pumping process. The actuator/generators 30 may also convert linear kinetic energy of the pistons into electrical current. In some embodiments, the actuator/generators 30a, 30b may be replaced by actuators, or be used only as actuators, in order to accomplish a pumping process.

A control unit 32 may be electrically coupled to the actuator/generators 30a, 30b to control them, to draw electrical current therefrom, or both. A load 34 such as a battery, motor, electronic device, or the like may electrically couple to the control unit 32 to be powered by electrical energy extracted from the alternator/generators 30a, 30b. An operator interface 36 may provide an interface with an operator to set parameters of the control unit 34, such as the operating speed, fuel intake, air intake, and like parameters. The load may also function as an energy source during specific phases of the fluid handling process.

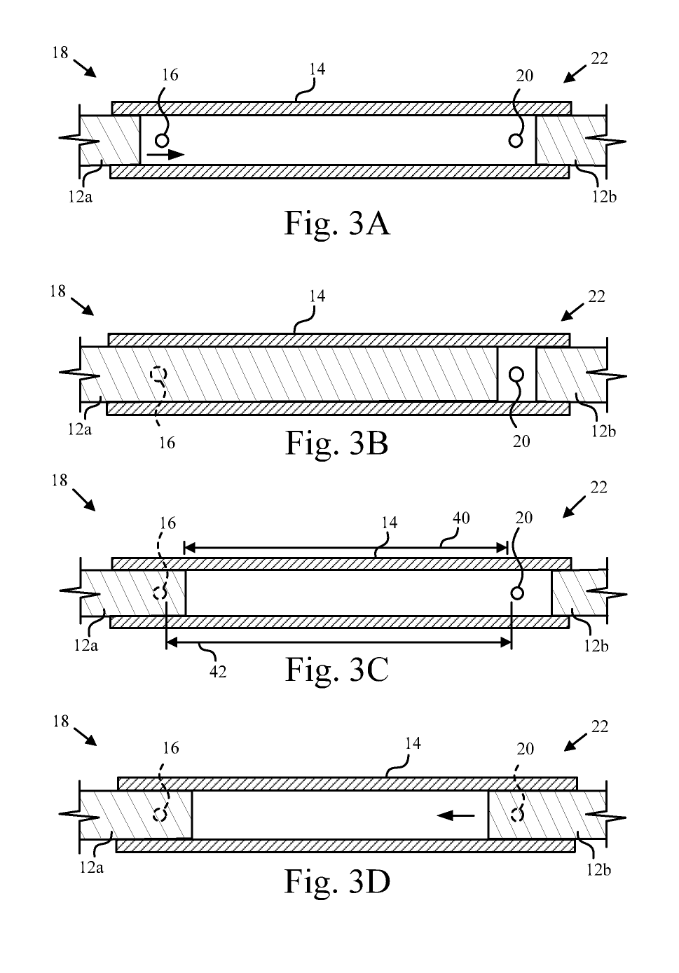

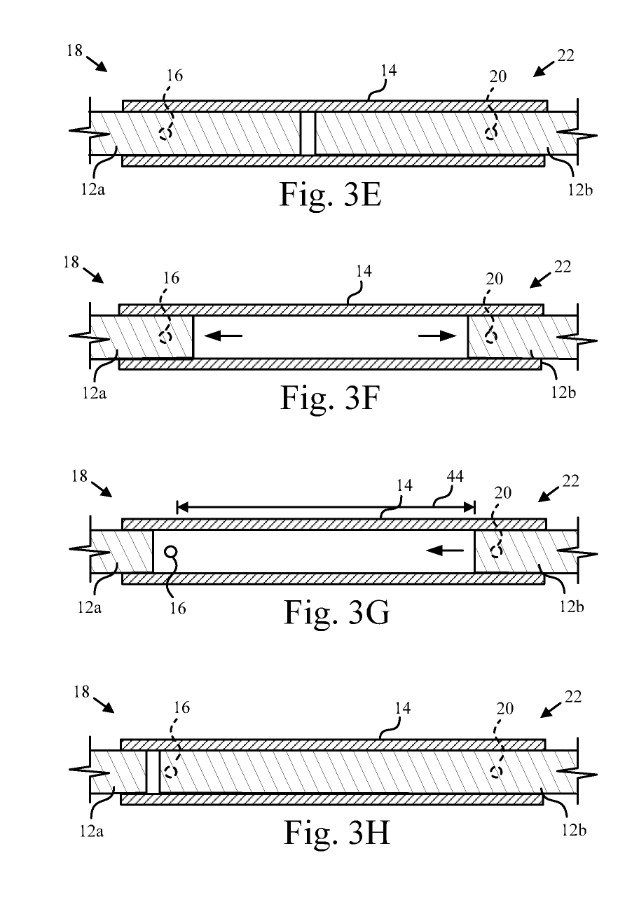

Referring to FIGS. 3A-3H, a control unit 32 may be programmed to cause the pistons 12a, 12b to execute a 5-phase combustion process. The 5-phase combustion process may be a mediated four-stroke combustion process and include a recovery phase to position the pistons 12a, 12b ready for the next iteration of the process.

Referring to 3A, prior to ignition, the pistons 12a, 12b may begin in the positions illustrated, positioned at the proximal end 18 and the distal end 22, respectively. Referring to FIG. 3B, the actuator/generator 30a may move the piston 12a toward the distal end 22 such that the piston 12a moves to a position near or past the intake port 20, effectively vacating the cylinder 14 in preparation for an intake phase. Referring to FIG. 3C, the actuator/generator 30b may effect the intake phase by moving the piston 12a distance 40 toward the proximal end 18 such that the entire piston 12a does not entirely pass the exhaust port 16, effectively sealing against the release of gasses through the exhaust port 16. The distance 40 traveled by the piston 12a during the intake phase depicted in FIG. 3C is the intake distance 40. The length of the intake distance may 40 be varied to control the efficiency of the engine.

For example, during the combustion process, the pressure and volume of gas within the cylinder 14 increases. Accordingly, in order for the post-combustion contents of the cylinder 14 to expand until they reach atmospheric pressure, the combustion chamber must expand to a volume significantly larger than the volume of the air going into the combustion process. In a conventional engine, because the cylinder has a fixed size, combustion gases cannot expand further and perform more useful work. Accordingly, exhaust gases are simply released and the potential work is wasted.

In the apparatus 10, the intake distance 40 may be controlled by the actuator/generator 30a such that the distance 40 is less than the distance 42 between the intake port 16 and exhaust port 20, which is the approximate point of maximum volume of the combustion chamber formed by the pistons 12a, 12b and the cylinder 14. Accordingly, post-combustion contents of the cylinder 14 can hyper-expand beyond their original volume.

Referring to FIG. 3D, the piston 12b may then be moved toward the proximal end 18 such that it seals off the intake port 20. Referring to FIG. 3E, the compression phase may be accomplished by causing the piston 12b to continue moving toward the proximal end 18 as the piston 12a moves toward the distal end 22 until the pistons 12a, 12b have compressed the gases therebetween sufficiently to accomplish a given combustion process. In embodiments of the apparatus 10 executing a Diesel cycle, fuel is injected at this point. In embodiments of the apparatus 10 executing an Otto cycle, a spark is produced to ignite the air-fuel mixture. In some embodiments, the fuel air mixture may be compressed such that the temperature thereof increases enough to cause auto-ignition (i.e. compression ignition) without the need for a spark. For Diesel apparatus, the fuel ignites upon contact with the compressed air, although a glow plug may also serve to increase the temperature. In some iterations of the process of FIGS. 3A-3H, a combustionless expansion phase may replace the combustion phase. To accomplish a combustionless expansion phase, the compressed gas is simply heated by residual thermal energy stored in the wall of the cylinder 14 and the pistons 12a, 12b, rather than by combustion of fuel.

Referring to FIG. 3F, after ignition or injection, the fuel burns and expands to effect the combustion phase, driving the piston 12a toward the proximal end 18 and driving the piston 12b toward the distal end 22. During the phase of FIG. 3F, the actuator/generators 30a, 30b extract electrical energy from the movement of the pistons 12a, 12b, such as by moving a magnet across a coil, or like process.

Referring to FIG. 3G, during the expansion phase the piston 12b may be moved to a position slightly proximal of the intake port 22, such that the intake port 22 remains sealed, whereas the piston 12a is moved to a position past the exhaust port 16. The distance 44 between the piston 12b and the exhaust port 16 represents the maximum volume of the combustion gases. Where the intake distance 40 is less than the distance 44, hyper-expansion is achieved.

Referring to FIG. 3H, during the exhaust phase, the actuator/generator 30b may move the piston 12b toward the proximal end 18 such that the combustion gases are driven out through the exhaust port 16. Referring again to FIG. 3B, during the recovery phase, the pistons 12a, 12b may move toward the distal end 22 in preparation for the next iteration of the process.

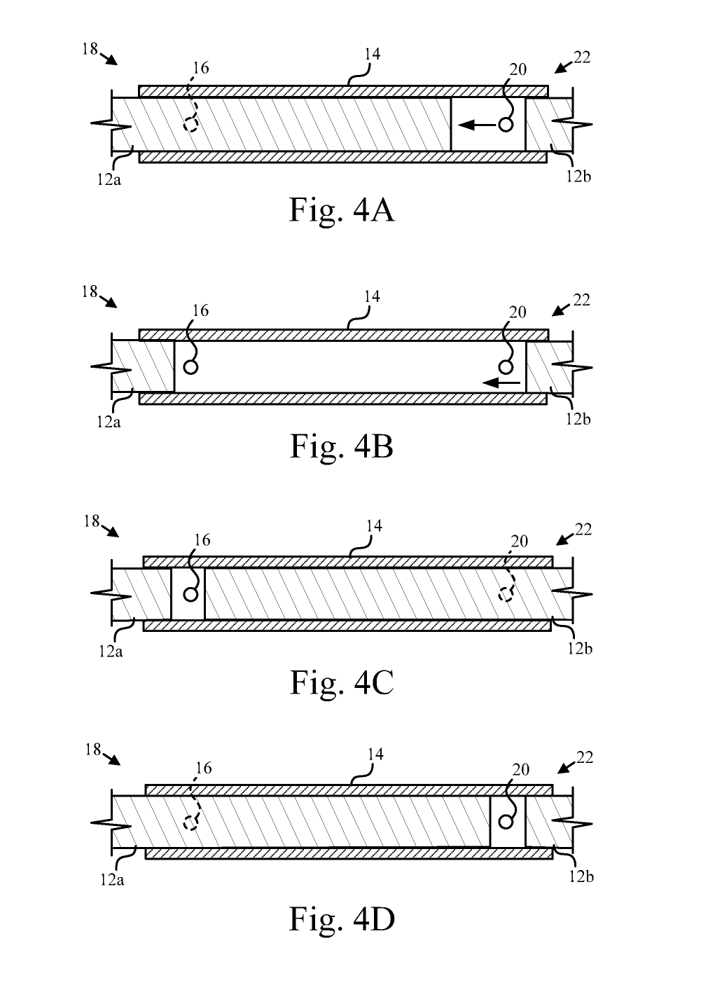

Referring to FIGS. 4A-4D, between iterations of the combustion process a cooling process may be executed to cool the pistons 12a, 12b and cylinder 14. Referring to FIG. 4A, the piston 12a may be moved from the position of FIG. 4A toward the distal end 18 past the exhaust port 16 into the position shown in FIG. 4B in order to draw cool air into the cylinder 14. The piston 12b may subsequently be moved toward the distal end 18 to the position of FIG. 4C, driving the air within the cylinder 14 out of the exhaust port 16. Referring to FIG. 4D, the pistons 12a, 12b may be moved toward the proximal end 22 in preparation for the next cooling process or combustion process. Multiple iterations of the cooling process of FIGS. 4A-4D may be performed based on the temperature of the engine. In some embodiments a temperature sensor may be read to determine when and how many times to perform the cooling process.

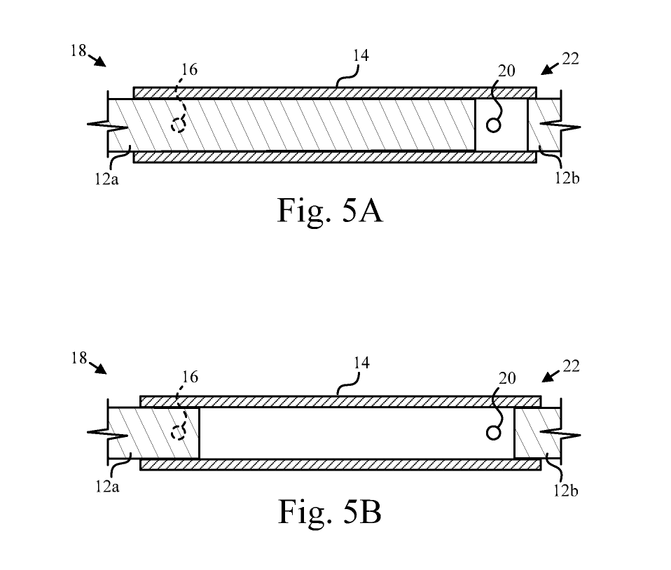

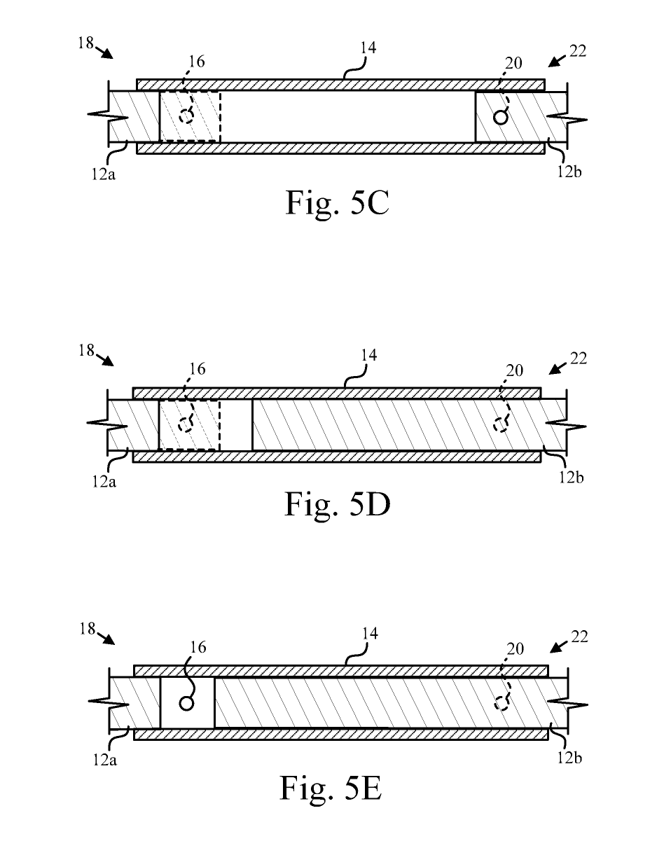

Referring to FIGS. 5A-5E, the apparatus 10 may be used to perform a pumping or compression process. Referring specifically to FIG. 5A, the pistons 12a, 12b may begin in the positions shown, with the piston 12b positioned between the distal end 22 and the intake port 20 and the piston 12a positioned near or over the intake port 20. Referring to FIG. 5B, the actuator/generator 30a may move the piston 12a toward the proximal end 18, drawing air or fluid into the cylinder 14. Referring to FIG. 5C, as the piston 12a approaches the exhaust port 16, the piston 12b may move to cover the intake port 20, such that pressurized fluid or air does not leak back into the cylinder 14 through the exhaust port 16 and out the intake port 20. In some embodiments, the apparatus 10 may pump electrically conductive fluids, such as between cells of an electrolytic battery, and therefore covering the intake port 20 before uncovering the exhaust port 16 inhibits creation of a conductive path from the intake port to the exhaust port 16.

In instances where the apparatus 10 is operating as a pump, the piston 12a may move expose the exhaust port 16 substantially immediately after, or simultaneous with, the sealing of the intake port 20 from the cylinder by the piston 12a. In instances where the apparatus 10 is operating as a compressor, the piston 12a, remains positioned over the exhaust port 16, as shown by the dotted representation of the piston 12a in FIG. 5C.

Referring to FIG. 5D, the piston 12b may continue to move toward the proximal end 18, either driving fluid out of the exhaust port 16 or compressing air within the cylinder 14, depending on the mode of operation of the apparatus 10. Referring to FIG. 5E, in instances where the apparatus 10 is operating as a compressor, the piston 12a may be moved toward the proximal end 18 to permit the compressed gas to flow out of the exhaust port 16. In both compressors and pumps, the pistons 12a, 12b are driven back to the positions shown in FIG. 5A in preparation for the next iteration of the process.

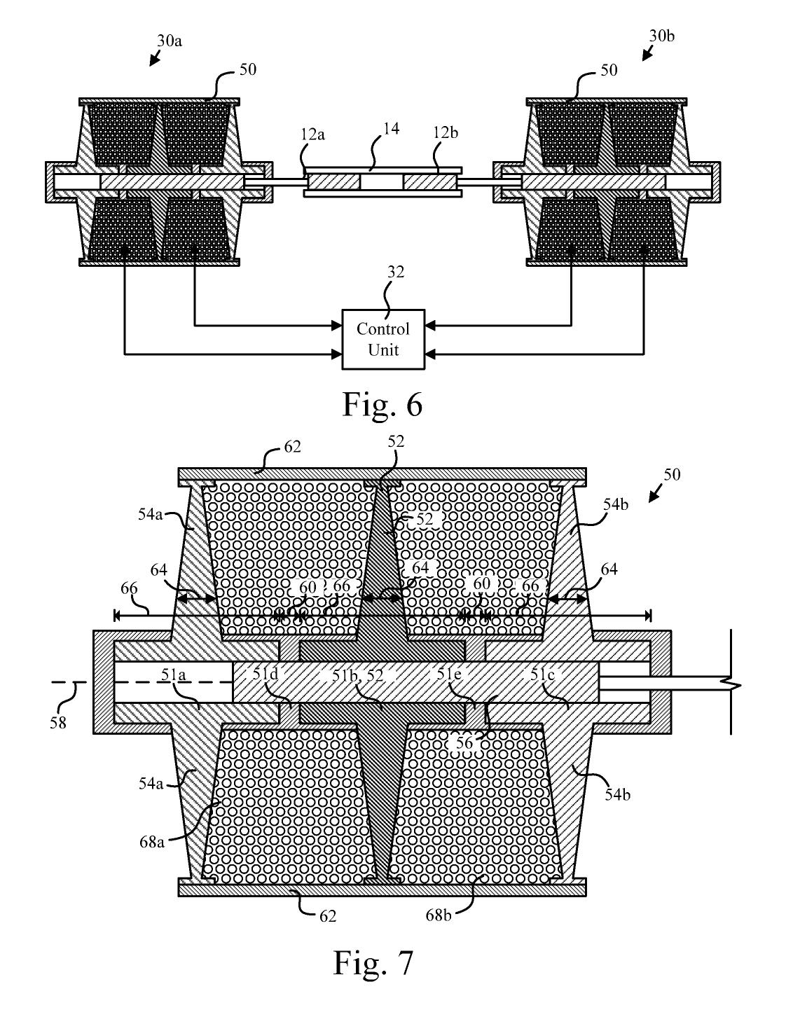

Referring to FIGS. 6 and 7, in one particular embodiment each actuator/generator 30a, 30b may be embodied as a linear switched reluctance motor (or generator) 50. Other examples of the actuator/generator 30a, 30b that are not depicted in detail herein include hydraulic actuators, voice coil actuators, stepper motors, and the like. The depicted motor 50 depicted in FIG. 7 may serve as the actuator/generator 30a. The actuator/generator 30b may be the minor image of the actuator/generator 30b or motor 50. Each motor 50 may include (a cylinder 51 with) an optional flux source 52, (i.e. center magnetic portion 51b that is optionally a hard magnet or connected with a hard magnet) flanked on either side by two alternate flux paths (i.e. left and right soft magnetic portions 51a and 51c) 54a, 54b. The flux source 52 and alternate flux paths 54a, 54b may surround a flux modulating piston 56 which is movable to close a magnetic circuit between one of the alternate flux paths and the flux source 52. In one embodiment, the flux source 52 is molded from a ferromagnetic material and radially magnetized to provide a substantially constant source of flux.

The illustrated flux source 52 and alternate flux paths 54a, 54b are substantially symmetrical about a longitudinal axis 58 of the flux modulating piston 56. The flux source 52 and alternate flux paths 54a, 54b may be spaced apart longitudinally along the flux modulating piston 56, with the flux source separated from each of the alternate flux paths 54a, 54b by a gap 60 filled with a nonferromagnetic material or simply air.

A flux bridge 62 may extend around the outer circumference of the flux source 52 and alternate flux paths 54a, 54b. The flux bridge 62 typically either contacts both the flux source 52 and alternate flux paths 54a, 54b or is attached thereto. The flux bridge 62 may be made of a magnetically permeable material to ensure that magnetic flux passes freely from the flux source 52 and the alternate flux paths 54a, 54b.

The radial cross section of the alternate flux paths 54a, 54b and flux source 52 may be chosen to ensure proper conduction of magnetic flux therealong. Inasmuch as the illustrated radial cross sections of the alternate flux paths 54a, 54b and flux source 52 are revolved around the longitudinal axis 58, the area through which magnetic flux must pass may be kept constant by narrowing the widths 64 thereof with distance from the longitudinal axis 58. Proximate the flux modulating piston 56, the alternate flux paths 54a, 54b and flux source 52 may have a widths 66 chosen to increase conduction of magnetic flux therefrom to the piston 56.

The piston 56 may be separated from alternate flux paths 54a, 54b and the flux source 52 by a small gap filled with air or lubricant to permit movement. Accordingly, increased widths 66 ensure flux conduction across the air gap substantially equal to the flux conduction of the alternate flux paths 54a, 54b and the flux source 52. Induction coils (i.e. left and right induction coils) 68a, 68b may be positioned around each alternate flux paths 54a, 54b, respectively. In the illustrated embodiments current flows circumferentially within the coils around the longitudinal axis 58. The (left and right) induction coils 68a, 68b may be electrically coupled to the control unit 32, which selectively permits current to flow through the coils 68a, 68b to accomplish the fluid handling processes discussed hereinabove.

The motor 50 may also function as a generator. When the piston 56 is compelled to move along its range of travel it modulates magnetic circuits between the flux source 52 and alternate flux paths 54a, 54b. As the circuits are modulated, the magnetic field incident on the coils 68a, 68b changes, generating an electric current in the coils 68a, 68b.

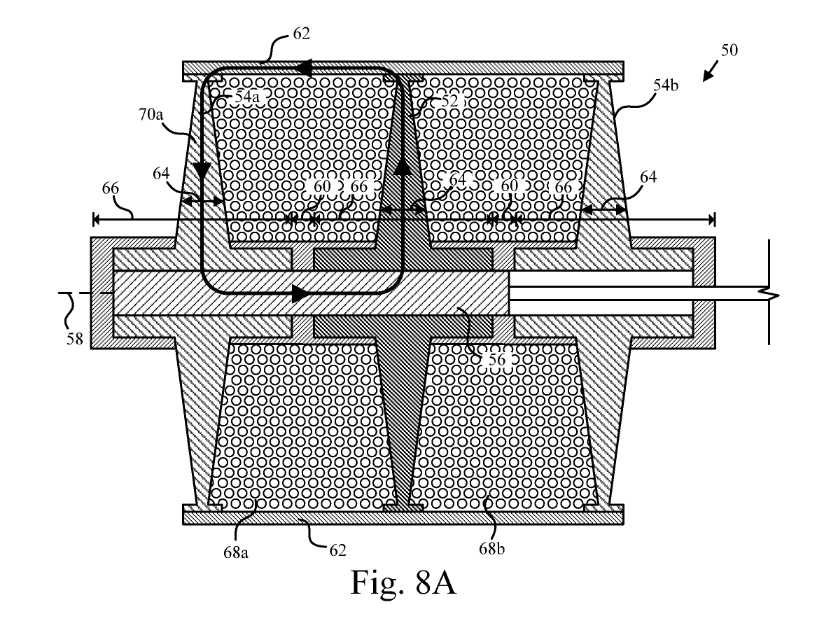

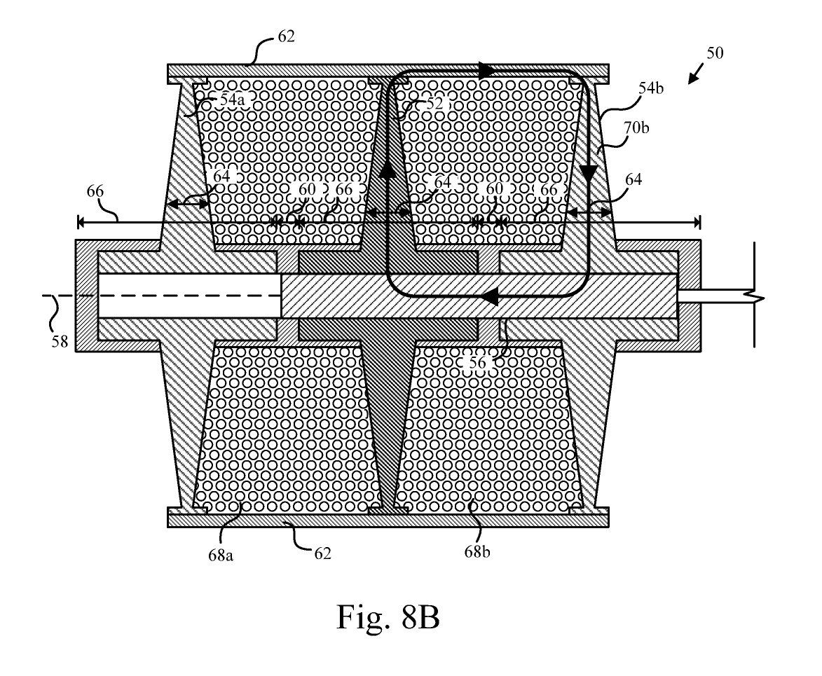

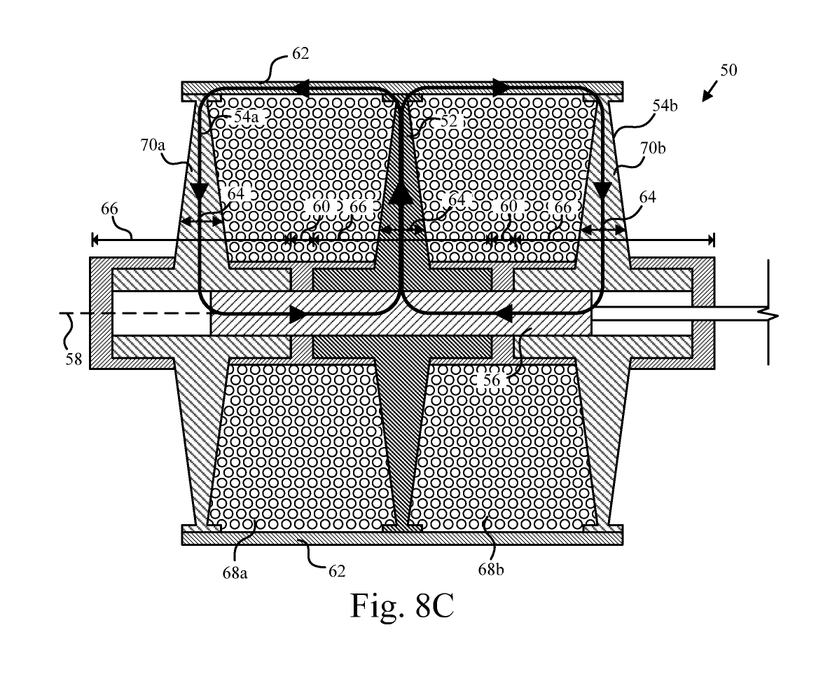

Referring to FIGS. 8A-8C, current may be provided to the coils 68a, 68b either one coil 68a, 68b at a time or both coils 68a, 68b together. Referring to FIG. 8A, as current flows through coil 68a, magnetic flux is induced in alternate flux path 54a, drawing the flux modulating piston 56 toward the alternate flux path 54a and completing a magnetic circuit 70a passing through the piston 56, alternate flux path 54a, flux bridge 62, and flux source 52. Referring to FIG. 8B, the coil 68b may be activated, drawing the flux modulating piston 56 toward the alternate flux path 54b and completing a magnetic circuit 70b passing through the piston 56, alternate flux path 54b, flux bridge 62, and flux source 52.

Referring to FIG. 8C, when a single coil 68a, 68b is activated, the flux modulating piston 56 will tend to maximize the flux flowing from itself to one of the alternate flux paths 54a, 54b. Accordingly, the piston will be compelled to move to maximize the overlap of the piston with one of the alternate flux paths 54a, 54b, depending on which coil 68a, 68b has been activated. At a certain point, the flux provided by the optional flux source 52 may be sufficient to drive the piston 56 toward a point of maximum overlap without providing current to the coils 68a, 68b. The piston 56 may consequently remain at or near the point of maximum overlap unless acted upon by other forces.

In some embodiments, the point of maximum overlap corresponds to the extreme ends of the range of travel of the piston 56. To achieve positions between the extreme ends of the range of travel of the piston 56, both coils 68a, 68b may be activated in equal or different degrees to cause the piston to move to a central position between the two alternate flux paths 54a, 54b or slightly offset therefrom.

In review, the linear motor or generator 50 may include a cylinder 51 having left, center, and right magnetic portions 51a, 51b, and 51c interposed with a left magnetic gap 51d and a right magnetic gap 51e, the left and right magnetic portions comprising a soft magnetic material, a left induction coil 68a and a right induction coil 68b axially wound around a longitudinal axis of the cylinder, a flux source for providing flux to the center magnetic portion, a flux bridge 62 that provides a left flux path 70a over the outer perimeter of the left induction coil and magnetically couples the center magnetic portion to the left magnetic portion, wherein the flux bridge further provides a right flux path 70b over the outer perimeter of the right induction coil and magnetically couples the center magnetic portion to the right magnetic portion, and a piston comprising a soft magnetic material for increasing magnetic flux circulation in the left flux path when the piston overlaps with the left magnetic gap and for increasing magnetic flux circulation in the right flux path when the piston overlaps with the right magnetic gap.

The flux source may be hard magnet that magnetically connects the center magnetic portion 51b to the flux bridge 62 or one of the coils (having current flowing therein). Driving the piston (from an external source or via internal combustion) may modulate the flux that circulates around the left and right induction coils and generate electrical power therein. The flux bridge may be integral to a chassis of the linear motor or generator. The left magnetic gap and the right magnetic gap may be made of a non-magnetic material or air.

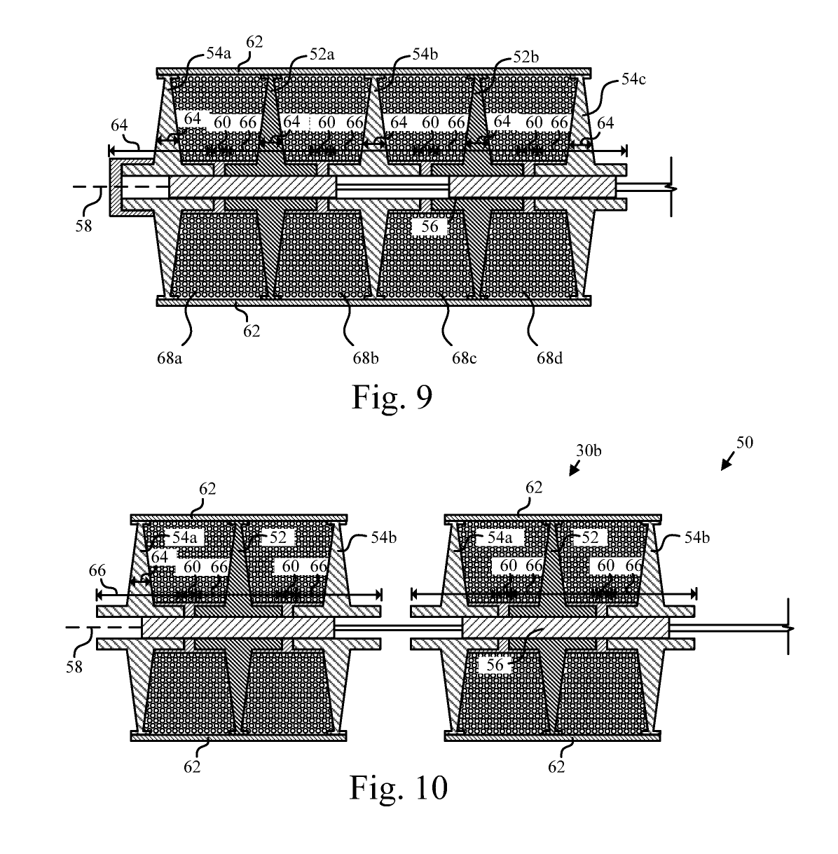

Referring to FIG. 9, in some embodiments, a greater number of positions may be achieved by activation of a single coil 68a, 68b by providing an alternating series of alternating flux sources 52a, 52b, separated by alternate flux paths 54a-54c each with a corresponding coils 68a-68d. Referring to FIG. 10, alternatively, multiple single-coil activation positions may be achieved using multiple motors 50a, 50b having their pistons 56 coupled together. The motors 50a, 50b may be out of phase with one another, such that the single coil activation positions of the first motor 50a fall between the single coil activation positions of the second motor 50b.

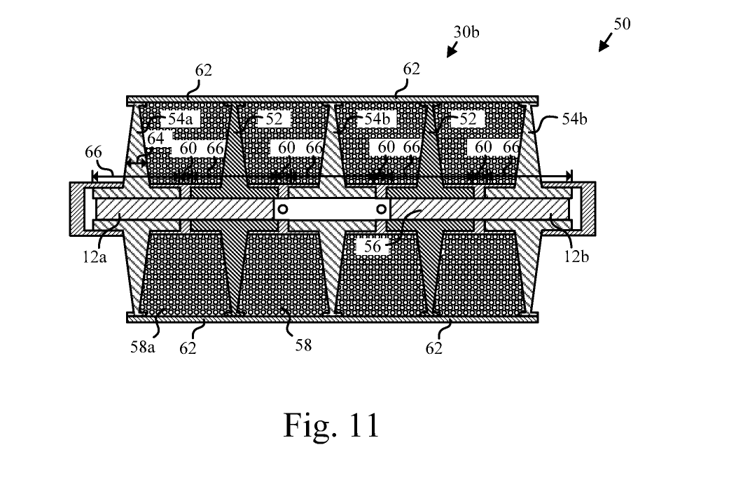

Referring to FIG. 11, in some embodiments, the flux modulating piston 56 may be integrated with a piston 12a, 12b. For example, the motor 50 of FIG. 10 may be modified to include two flux modulating pistons 56a, 56b and have the exhaust port 16 and intake port 20 formed in the channel in which the pistons 56a, 56b travel. Accordingly, the flux modulating pistons 56a, 56b would execute the processes as described above for the pistons 12a, 12b, respectively.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A linear motor or generator comprising:
a cylinder comprising left, center, and right magnetic portions interposed with a left magnetic gap and a right magnetic gap, the left and right magnetic portions comprising a soft magnetic material;
a left induction coil and a right induction coil axially wound around a longitudinal axis of the cylinder;
a flux source for providing flux to the center magnetic portion;
a flux bridge that magnetically couples the center magnetic portion to the left magnetic portion and thereby provides a left flux path over the outer perimeter of the left induction coil;
wherein the flux bridge magnetically couples the center magnetic portion to the right magnetic portion and thereby provides a right flux path over the outer perimeter of the right induction coil;
a flux modulating piston comprising a soft magnetic material for increasing magnetic flux circulation in the left flux path when the piston overlaps with the left magnetic gap and for increasing magnetic flux circulation in the right flux path when the piston overlaps with the right magnetic gap.

2. The motor or generator of claim 1, wherein the flux source is a hard magnet that magnetically connects the center magnetic portion to the flux bridge.

3. The motor or generator of claim 1, wherein the hard magnet is a radial magnet.

4. The motor or generator of claim 1, wherein the flux source is the left induction coil or the right induction coil.

5. The motor or generator of claim 1, wherein the flux bridge is integral to a chassis of the linear motor or generator.

6. The motor or generator of claim 1, wherein the left magnetic gap or the right magnetic gap comprises a non-magnetic material.

7. The motor or generator of claim 1, wherein the left magnetic gap or the right magnetic gap comprises air.
